(19) United States
(12) Patent Application Publication
(10) Pub. No.: US 2004/0110026 A1
(43) Pub. Date: Jun. 10, 2004

(54) Electroluminescent coating system

(75) Inventors: Bradley M. Richards, Maumee, OH (US); Anthony B. Dyach, Farmington Hills, MI (US)

Correspondence Address: BASF CORPORATION, ANNE GERRY SABOURIN, 26701 TELEGRAPH ROAD, SOUTHFIELD, MI, 48034-2442, US

(73) Assignee: BASF CORPORATION, Mount Olive, NJ (US)

(21) Appl. No.: 10/065,986

(22) Filed: Dec. 6, 2002

(51) Int. Cl. B32B 9/00; B32B 3/10; H05B 33/00

(52) U.S. Cl. 428/690; 428/917; 428/201; 428/203; 428/207

(57) ABSTRACT

An electroluminescent (EL) coating system is applied to a substrate. The EL coating system includes a color-providing film layer applied to said substrate, a mid-coat film layer applied to the color-providing film layer, and a clearcoat film layer applied to the mid-coat film layer. The color-providing film layer includes an EL phosphor.

### BACKGROUND OF INVENTION

1. Field of the Invention

The subject invention generally relates to an electroluminescent (EL) coating system, including an EL phosphor, that is applied on a substrate. More specifically, the subject invention relates to a tri-coat EL coating system applied to an automotive body panel where the EL phosphor is preferably excited by electrical induction.

2. Description of the Related Art

Use of normal phosphorescent pigments or normal phosphors is known. Normal phosphors, as opposed to EL phosphors, accumulate energy from an external light source, such as the sun, and luminesce for a limited period of time as a result of this accumulated energy. In U.S. Pat. Nos. 5,472,737 and 5,874,491 normal phosphors are incorporated into phosphorescent paint compositions that are used as highway or roadway paint compositions. Use of normal phosphors in automotive and other coating systems is also known in the art. For instance, U.S. Pat. No. 6,242,056 incorporates normal phosphors, specifically phosphorescent-coated beads, into reflective, heat-cured paint coating systems to enhance the light emission of the paint coating system.

The conventional use of normal phosphors in conventional coating systems is inadequate for various reasons. For instance, the conventional use of normal phosphors in conventional coating systems is inadequate because these conventional coating systems are not tri-coat coating systems. That is, these conventional coating systems do not have a mid-coat film layer applied between a color-providing film layer, having an EL phosphor, and a clearcoat film layer. As such, these coatings systems, i.e., coating systems without a mid-coat film layer, do not provide for the selective masking off of certain portions of the color-providing film layer to generate unique design effects for a vehicle thereby enhancing the aesthetics of the vehicle. Such unique design effects can be established by the strategic blocking of certain portions of the EL phosphor in the color-providing film layer.

The conventional use of phosphorescent pigment in conventional coating systems is also inadequate because many compositions that are used to form the coating systems with the phosphorescent pigment are not cross-linkable. Examples of compositions that are not cross-linkable are disclosed in the ″737 and ″491 patents. Due to the lack of cross-linking, these compositions are not suitable for automotive coating systems where durability and the physical integrity of the coating system, relative to weathering and exposure, are paramount. Furthermore, many coating systems, such as the coating system disclosed in U.S. Pat. No. 5,998,525, do not provide for multiple film layers for making-up the coating system. For example, these coating systems do not include a clearcoat film layer to achieve excellent gloss and DOI. For these reasons, the prior art compositions are not suitable for automotive coating systems where multiple film layers are required that provide acceptable appearance, as measured by gloss and DOI. In fact, some DOI measurements for the prior art compositions do not even register on typical DOI meters.

EL phosphors exhibit electroluminescence in response to application of an alternating current voltage to the EL phosphor. EL phosphors may also exhibit electroluminescence in response to an electrical field generated by the alternative current voltage. Although EL phosphors are known and used throughout certain industries, such as the watch and lighting industries, EL phosphors have not been incorporated into systems that are suitable as automotive coating systems. As such, an operator of a vehicle cannot selectively activate the coating system on the vehicle to luminesce whenever the operator desires. Furthermore, because EL phosphors have not been incorporated into automotive coating systems, there is no coating system that makes use of the electricity of the vehicle to effectively control the duration of the luminescence of the coating system. Other coating systems that merely incorporate a normal phosphor are dependent on the amount of energy accumulated by the normal phosphor.

The coating systems and compositions of the prior art are characterized by one or more inadequacy. As a result, it is desirable to implement an EL coating system that is a tri-coat coating system including a mid-coat film layer that can selectively mask an EL phosphor to generate unique design effects. It is also desirable that the EL coating system be cross-linkable and suitable for application to an automotive body panel. It is also desirable for the EL phosphor to be excited by electrical induction.

### SUMMARY OF INVENTION

An EL coating system is disclosed. The EL coating system includes a substrate. A color-providing film layer is applied to the substrate. The color-providing film layer includes an EL phosphor. The color-providing film layer can be a decal or can be formed from a color-providing composition. An least partially-transparent mid-coat composition is applied to the color-providing film layer to form an at least partially-transparent mid-coat film layer. An at least partially-transparent clearcoat composition is applied to the mid-coat film layer to form an at least partially-transparent clearcoat film layer. The color-providing film layer, the mid-coat film layer, and the clearcoat film layer establish a tri-coat coating system. The mid-coat film layer in this tri-coat coating system can be applied to selectively mask the EL phosphor to generate unique design effects for the EL coating system. Preferably, at least one of the film layers is formed from a composition that is cross-linkable such that the EL coating system is optimum for application to automotive body panels. It is also preferred that the EL phosphor in the color-providing film layer is excited by electrical induction.

### BRIEF DESCRIPTION OF DRAWINGS

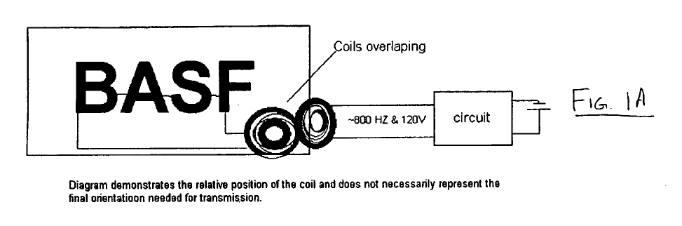

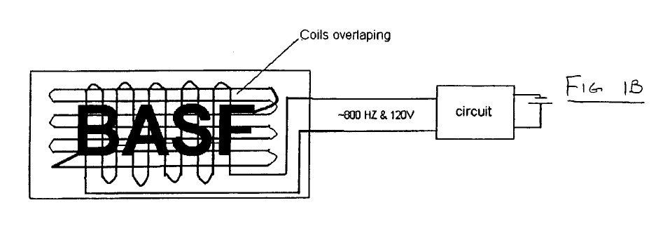

Other advantages of the present invention will be readily appreciated as the same becomes better understood by reference to the following detailed description when considered in connection with the accompanying drawings

wherein:FIG._1_IS_{——}FIG. 1_IS_{——}FIG. 1A includes a schematic electrical diagram illustrating the use of electrical induction to excite an EL coating system having an EL phosphor; and FIG. 1B includes a schematic electrical diagram illustrating a primary and secondary induction coil intertwined with a color-providing film layer, i.e., decal.

### DETAILED DESCRIPTION

An electroluminescent (EL) coating system according to the subject invention includes a substrate, a color-providing film layer, an at least partially-transparent mid-coat film layer, and an at least partially-transparent clearcoat film layer. As such, in the most preferred embodiment, the EL coating system is a tri-coat coating system, i.e., a coating system having three layers (in addition to the substrate). The color-providing film layer is applied to the substrate and includes EL phosphor. The at least partially-transparent mid-coat film layer is formed from an at least partially-transparent mid-coat composition that is applied to the color-providing film layer, and the at least partially-transparent clearcoat film layer is formed from an at least partially-transparent clearcoat composition that is applied to the mid-coat film layer.

For descriptive purposes of the subject invention, “at least partially-transparent” is intended to describe film layers and compositions that are partially-transparent as well as fully-transparent. Partially-transparent film layers and compositions generally transmit at least 10%, preferably at least 30%, of incident light. The at least partially-transparent mid-coat film layer and the at least partially-transparent mid-coat composition are hereinafter referred to as the mid-coat film layer and the mid-coat composition, respectively. Similarly, the at least partially-transparent clearcoat film layer and the at least partially-transparent clearcoat composition are hereinafter referred to as the clearcoat film layer and the clearcoat composition, respectively.

The color-providing film layer, i.e., the base or ground coat layer, is applied to the substrate. The color-providing film layer can be a decal that is adhered to the substrate. Alternatively, the color-providing film layer can be formed from a color-providing composition that is applied to the substrate. In either the decal embodiment or the composition embodiment, the color-providing film layer includes the EL phosphor.

If the color-providing film layer is formed from the color-providing composition, then the color-providing composition is preferably spray applied to the substrate. As such, the color-providing composition is preferably a liquid that is spray applied to the substrate by air- or rotary-atomized application equipment that is known in the art. However, if the color-providing composition may also be a powder or powder slurry composition, and may even by applied according to different application methods including, but not limited to, electro-deposition, dip-applying, roll-applying, and the like.

In the embodiment where the color-providing film layer is formed from a color-providing composition, the color-providing compositions that are suitable for use in the subject invention include any of a number of types of color-providing compositions known in the art. For the purposes of the subject invention, the types of color-providing compositions do not require explanation in detail as the particular color-providing composition that is utilized does not vary the scope of the subject invention.

Generally, the types of color-providing compositions suitable for application in the subject invention include, but are not limited to, solventborne and waterborne compositions, refinish and OEM-type compositions, and thermosetting and thermoplastic compositions. More specifically, polymers known in the art to be useful in the color-providing compositions include acrylics, vinyls, polyurethanes, polycarbonates, polyesters, alkyds and polysiloxanes. Preferred polymers include acrylics, polyurethanes, and polyesters. As indicated above, the polymer in the color-providing composition may be thermoplastic, but is preferably cross-linkable and therefore includes one or more cross-linkable functional groups. Suitable cross-linkable functional groups include, but are not limited to, hydroxy, isocyanate, acid, amine, epoxy, acrylate, vinyl, silane, anhydride, and acetoacetate cross-linkable functional groups. The cross-linkable functional groups may be masked or blocked in such a manner that they become unblocked and therefore available for cross-linking under preferred cure conditions, such as elevated temperatures. These polymers may be self cross-linkable, or may require a separate cross-linking agent that is reactive with the cross-linkable functional groups of the polymer. For example, when the polymer includes a hydroxy cross-linkable functional group, the cross-linking agent may be an aminoplast resin, such as melamine, an isocyanate cross-linking agent, a blocked isocyanate cross-linking agent, an acid, or an anhydride cross-linking agent.

The color-providing film layer includes the EL phosphor. Although not preferred, the other film layers, specifically the mid-coat film layer and the clearcoat film layer, may also include EL phosphor. Depending on the color desired for electroluminescence, the EL phosphor in the color-providing film layer includes various components. Generally, for green, blue, blue-green, and green-yellow electroluminescence, the EL phosphor includes copper-doped zinc sulfide. Alternatively, for these colors of electroluminescence, the EL phosphor may include a zinc-sulfide based phosphor activated with a rare earth element, a strontium-aluminate based phosphor activated with a rare earth element, or combinations thereof. Rare earth elements are understood to include the elements having atomic numbers from 57 to 71 in the Periodic Table of Elements. For red electroluminescence, the EL phosphor may be described to be of the general formula SrS:Eu:X, where X is selected from the group consisting of chlorine, bromine, rare earth elements, and combinations thereof. One suitable EL phosphor is commercially available as Phosphorescent Pigment 6SSU from United Mineral & Chemical Corporation, Lyndhurst, N.J.

To broaden the range of colors that are available in the color-providing film layer, the color-providing film layer may further include an at least partially-transparent pigment in combination with the EL phosphor. Generally, any other pigment, either organic or inorganic is suitable for combination, or co-blending, with the EL phosphor so long as the pigment is at least partially-transparent such that the electroluminescence of the EL phosphor can display through the color effect of the combined pigment. Retroreflective microspheres, as are known in the art, may also be used in combination with the EL phosphor.

Although the EL phosphor may be excited by direct electrical contact, it is preferably excited by electrical induction. Referring to FIGS. 1A and 1B, a color-providing film layer forming the letters “B A S F” is applied on a substrate. In this Figure, the color-providing film layer is a decal adhered on the substrate. However, it is to be understood that a color-providing composition could also be applied, e.g. spray applied, to the substrate to form the letters “B A S F” or any other letters, designs, etc.

In FIGS. 1A and 1B, a power supply, such as a car battery, provides direct current (DC) to an electrical circuit. This electrical circuit converts the DC to alternating current (AC), which is required for electrical induction. The AC, at approximately 800 Hz and 120V, is then supplied to a primary induction coil. The AC in the primary induction coil generates a magnetic field that induces a current to flow in a secondary induction coil. The current from the secondary induction coil excites the EL phosphor in the color-providing film layer to electroluminesce. The two schematic electrical diagrams included in FIGS. 1A and 1B are examples of the relative positions for the primary and second induction coils. These diagrams do not necessarily represent the final orientation needed for optimum excitation of the EL phosphor in the color-providing composition. Importantly, the use of electrical induction to excite an EL phosphor can be used in a coating system regardless of whether or not the coating system is a tri-coat coating system. The EL coating system of the subject invention may also include normal phosphors such as zinc sulfide, or radioactive substances such as radioisotopes.

In the embodiment where the color-providing film layer is formed from the color-providing composition, the color-providing composition is applied to the substrate thereby forming an uncured, or wet, film layer of the color-providing composition. It is to be understood that, for purposes of the subject invention, if any of the compositions are based on waterborne technology, then the terminology “uncured”is intended to include the pre-bake or pre-cure conditions (i.e., the low bakes or warm air drying) that are typically associated with compositions of waterborne technology. Preferably, the color-providing composition is applied to a film build that is suitable for completely hiding an underlying color of the substrate. Of course, this film build is color dependent. Although not required, the uncured film layer of the color-providing composition is preferably cured to form the color-providing film layer.

Next, the at least partially-transparent mid-coat composition is applied to color-providing film layer to form the mid-coat film layer If the color-providing film layer is the decal, then the mid-coat composition is applied over the decal onto the substrate. The types of compositions suitable for the mid-coat composition are the same as those described above with respect to the color-providing composition. The mid-coat composition may include only at least partially-transparent pigmentation, only opaque pigmentation, or combinations of the two types of pigmentation. Either pigmentation may be organic or inorganic. Retroreflective microspheres may also be used in the mid-coat composition.

It is preferred that the mid-coat composition include some opaque pigmentation to establish unique design effects between the combination of the color-providing film layer and the mid-coat film layer. The opaque pigmentation is used to strategically or selectively mask, i.e., block, off certain portions of the electroluminescence from the EL phosphor. As a non-limiting example, after the color-providing film layer, with the EL phosphor, is established, certain portions of the color-providing film layer can be masked off to in the form of a design, shape, letters, etc., to be visual as a result of the electroluminescence of the EL phosphor. Of course, if masking of the color-providing film layer is required, then it is preferred that the color-providing film layer is completely cured so that masking tape, or some other effective blocking tool, can be conveniently applied to the layer. After masking, the mid-coat composition, containing some amount of opaque pigmentation, can be applied to the color-providing film layer (either the decal or the color-providing composition). The masking can then be removed, and when the EL phosphor is activated, the design, shape, letters, etc., with electroluminesce with the mid-coat film layer as a backdrop. The mid-coat composition can be cured prior to application of the-clearcoat composition or the mid-coat composition can remain wet, in an uncured state, and the clearcoat composition can be applied wet-on-wet to the uncured mid-coat composition.

Importantly, it is to be understood that there can be more than one mid-coat film layer depending on the final design that is desired. For example, a first mid-coat film layer can be established with the primary objective of providing opaque pigmentation to achieve optimum masking. After masking the electroluminescence of the EL phosphor where desired, a second mid-coat film layer can be established on the first mid-coat film layer to add further pigmentation, to improve appearance, to add additional EL or normal phosphor, and the like. Even if more than one mid-coat film layer is included, the EL coating system of the subject invention is still effectively a tri-coat coating system in that there is a color-providing film layer, a mid-coat film layer (formed from several mid-coat film layers), and a clearcoat film layer. With the tri-coat coating system, the key is that there is at least one film layer between the color-providing film layer and the clearcoat film layer to some how modify the electroluminescence of the color-providing film layer to create designs, shapes, and the like.

The at least partially-transparent clearcoat composition is applied to the mid-coat film layer to form the at least partially-transparent clearcoat film layer. The clearcoat film layer optimizes appearance and durability of the overall EL coating system. The clearcoat compositions suitable to be utilized in the subject invention include any of a number of types of clearcoat compositions known in the art. For the purposes of the subject invention, the types of clearcoat compositions do not require explanation in detail as the particular clearcoat composition that is utilized does not vary the scope of the subject invention.

Generally, the types of clearcoat compositions suitable for application in the subject invention include, but are not limited to, solventborne and waterborne clearcoat compositions, refinish and OEM-type clearcoat compositions, powder and powder slurry clearcoat compositions, and thermosetting and thermoplastic clearcoat compositions. More specifically, polymers known in the art to be useful in the clearcoat compositions include acrylics and polyurethanes cross-linkable with melamine or isocyanate. Polymers for the clearcoat composition preferably have a cross-linkable functional group including, but not limited to, hydroxy, phenol, amino, carboxyl, epoxy, or mercaptan functional groups. Other clearcoat compositions suitable for use in the subject invention are based on carbonate chemistry, carbamate chemistry, and silane chemistry as known in the art. Suitable cross-linking agents reactive with the cross-linkable functional group of the polymer in the clearcoat composition include, but are not limited to, melamine, blocked and unblocked isocyanate, and combinations thereof. As understood by those skilled in the art, the clearcoat composition may include additional components such as ultraviolet light absorbers, hindered amine light stabilizers, surfactants, stabilizers, fillers, wetting agents, rheology control agents, dispersing agents and adhesion promoters. While use of these additional components in clearcoat compositions is well known in the art, the amount or amounts used are varied and controlled to avoid adversely affecting various physical properties of the EL coating system.

Although not required, it is preferred that all of the compositions are cross-linkable. It is also preferred that all of the uncured film layers are simultaneously cured to minimize the number of ovens required to establish the EL coating system of the subject invention. However, as alluded to above, if selective masking is required, then it may be ideal to include cures between applications of the various film layers, where necessary. Although various methods may be used for curing, heat-curing is preferred. Generally, heat curing is conducted by exposing the coating system on the substrate to elevated temperatures provided primarily by radiating heat sources. As understood by those skilled in the art, preferred conditions for cure vary depending on the type (i.e., the chemistry and polymer make-up) of the various compositions. More specifically, curing temperatures vary depending on the particular blocking groups used in the cross-linking agents. Generally, however, the curing temperatures range from 250 degree F. to 385 degree F. The duration of the cure may also vary depending on the chemistry and polymer make-up, on the particular cross-linking agents, and on physical parameters of the coating system such as the film build. Generally, the duration of the cure ranges from 15 to 60 minutes. Of course, as is known in the art, if the compositions are refinish-type compositions, which are typically highly catalyzed compositions, then the curing temperatures range from 120 degree F. to 190 degree F.

For purposes of the subject invention, the terminology of color-providing composition is intended to include any composition that can modify an original color of an underlying substrate, so long as the color-providing composition includes the EL phosphor. General examples of such color-providing compositions include, without limitation, pigmented basecoat compositions having organic pigments, inorganic pigments, metallic flakes, and/or mica flakes; clear binder compositions including only the EL phosphor, and partially-clear, or transparent, binder compositions such as tinted clearcoat compositions, so long as the tinted clearcoat composition also includes the EL phosphor.

As described above, the EL phosphor provides the electroluminescence for the coating system on the substrate. Although the coating system is preferably provided on a body panel of an automobile, i.e., an automotive body panel, as the substrate, the coating system may be applied to other suitable substrates such as concrete, blacktop, highway markers, construction markers, boats, airplanes, recreational vehicles, appliances, and the like. Furthermore, although the coating system is preferably applied to an automotive body panel that is metallic, the coating system may alternatively be applied to other automotive body panels including, but not limited to, plastic substrates such as a bumper, mirror, or internal dashboard of the automobile, aluminum substrates, and galvanized steel substrates.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

1. An electroluminescent coating system comprising:
a substrate;
a color-providing film layer applied to said substrate, said color-providing film layer comprising an electroluminescent phosphor;
an at least partially-transparent mid-coat film layer formed from an at least partially-transparent mid-coat composition applied to said color-providing film layer; and
an at least partially-transparent clearcoat film layer formed from an at least partially-transparent clearcoat composition applied to said mid-coat film layer.

2. An electroluminescent coating system as set forth in claim 1 wherein said electroluminescent phosphor in said color-providing film layer is excited by electrical induction.

3. An electroluminescent coating system as set forth in claim 1 wherein said color-providing film layer is further defined as a decal adhered to said substrate.

4. An electroluminescent coating system as set forth in claim 1 wherein said color-providing film layer is formed from a color-providing composition applied to said substrate.

5. An electroluminescent coating system as set forth in claim 4 wherein said color-providing composition is spray applied to said substrate.

6. An electroluminescent coating system as set forth in claim 1 wherein said mid-coat composition comprises an opaque pigment for selective masking of said color-providing film layer.

7. An electroluminescent coating system as set forth in claim 1 wherein said mid-coat composition comprises an at least partially-transparent pigment.

8. An electroluminescent coating system as set forth in claim 1 wherein said color-providing film layer further comprises an at least partially-transparent pigment in combination with said electroluminescent phosphor.
